(19) United States
(12) Patent Application Publication
(10) Pub. No.: US 2024/0301730 A1
(43) Pub. Date: Sep. 12, 2024

(54) DEPLOYMENT METHOD AND APPARATUS

(71) Applicant: JAGUAR LAND ROVER LIMITED, Warwickshire (GB)

(72) Inventors: Howard SISWICK, Whitley, Coventry, Warwickshire (GB); David WADDELL, Whitley, Coventry, Warwickshire (GB)

(21) Appl. No.: 18/262,656

(22) PCT Filed: Feb. 3, 2022
(86) PCT No.: PCT/EP2022/052634

§ 371 Date: Jul. 24, 2023

(30) Foreign Application Priority Data
Feb. 5, 2021 (GB) 2101637.3

(51) Int. Cl. E05B 85/10

(52) U.S. Cl. CPC E05B 85/107

(57) ABSTRACT

The present disclosure relates to a system (1) for controlling at least one handle deployment mechanism (9-n) associated with an aperture closure member (7-n) of a vehicle (3). The system (1) includes a transceiver (29) for communicating with at least one device (33); and a control unit (20). The control unit (20) has one or more controller (21) configured to identify one of the at least one device (33) as an authorised device (33). The control unit (20) may determine a location of the or each authorised device (33) in relation to the vehicle (3). The determined location of the or each authorised device (33) is compared to one or more target zone (Zn). The control unit (20) is configured to actuate the handle deployment mechanism (9-n) to deploy a handle (11-n) in dependence on a determination that the or each authorised device (33) is located within the target zone (Zn) or one of the target zones (Zn). The present disclosure relates to a vehicle (3) including the system (10) for controlling deployment of a handle (11-n); and method of controlling deployment of a handle (11-n).

### TECHNICAL FIELD

The present disclosure relates to a deployment method and apparatus. The present disclosure relates to a method and apparatus for controlling vehicle systems to facilitate a passenger pickup. More particularly, but not exclusively, the present disclosure relates to a method and apparatus for controlling deployment of a handle or a side step to facilitate passenger pickup.

### BACKGROUND

It is known to provide a retractable handle on a vehicle door. The handle typically retracts when the vehicle is travelling above a predetermined velocity threshold to improve the aerodynamic efficiency of the vehicle. If the vehicle subsequently slows, for example to perform a passenger pickup, the handle may remain in the retracted position. A user input, for example by the driver or the prospective passenger, may be required to deploy the handle. This may lead to a delay before the door may be opened to provide access to an interior of the vehicle. A similar situation may arise when a latch mechanism is activated to lock the door, for example when the vehicle reference velocity increases above a threshold value. A user input may be required to unlock the door.

At least in certain embodiments, the present invention seeks to overcome or ameliorate the problem(s) associated with the prior art systems.

### SUMMARY OF THE INVENTION

Aspects of the present invention relate to a system for controlling a handle deployment mechanism; a vehicle; a method of controlling deployment of a handle; and a non-transitory computer-readable medium as claimed in the appended claims.

According to an aspect of the present invention there is provided a system for controlling at least one handle deployment mechanism associated with an aperture closure member of a vehicle; the system comprising:
a transceiver for communicating with at least one device; and
a control unit comprising one or more controller configured to:
   identify one of the at least one device which is an authorised device;
   determine a location of the or each authorised device in relation to the vehicle;
   compare the determined location of the or each authorised device to one or more target zone; and actuate the handle deployment mechanism for deployment of a handle in dependence on a determination
that the or each authorised device is located within the target zone or one of the target zones.

The one or more controller is operable to identify the presence of the at least one authorised device disposed external to the vehicle. The identification of the authorised device provides an indication of a prospective passenger for the vehicle. The handle deployment mechanism may be actuated to deploy the handle to facilitate opening of the closure member. At least in certain embodiments, the handle deployment mechanism may be actuated while the vehicle is still moving. This may provide an approach deployment function comprising at least partially deploying the handle as the vehicle approaches the authorised device (which may be assumed to be on the person of a prospective passenger). The system has particular application in actuating the handle deployment mechanism to facilitate a passenger pickup.

The at least one device may be a portable device. The at least one device may be disposed outside of the vehicle.

The authorised device may, for example, comprise one of the following: a key fob, a computational device, and a cellular telephone. The cellular telephone may have a general-purpose computational processing capability (such as a so-called “smart phone”). The authorised device may provide passive entry to the vehicle, for example providing an automated door unlock function. The authorised device may be an authorised customer identification device (CID), such as a key fob, a smart phone, etc.

The one or more controller may collectively comprise: at least one electronic processor having an electrical input for receiving a reference velocity signal indicating a reference velocity of the vehicle; and at least one memory device electrically coupled to the at least one electronic processor and having instructions stored therein. The at least one electronic processor may be configured to access the at least one memory device and execute the instructions therein so as to determine the location of the at least one authorised device.

The at least one electronic processor may have at least one output for outputting a first actuation signal to actuate the handle deployment mechanism.

The identification of the authorised device may comprise generating a polling signal to initiate communication with one or more authorised device. The polling signal may be transmitted by the transceiver. The generation of the polling signal may be initiated in dependence on a determination that a vehicle reference velocity has decreased to less than a first velocity threshold. Alternatively, a transmission rate of the polling signal may be increased in dependence on a determination that a vehicle reference velocity has decreased to less than a first velocity threshold. The polling signal may be transmitted at a first transmission rate when operating in a default or maintain mode. The polling signal may be transmitted at a second transmission rate when operating in a search mode. The first transmission rate may be less than the second transmission rate. The first transmission rate may, for example, comprise transmitting the polling signal once every three (3) seconds (corresponding to a transmission rate of twenty (20) signals per minute). The second transmission rate may, for example, comprise transmitting the polling signal once a second (corresponding to a transmission rate of 60 signals per minute). A third transmission rate may be applied, for example if communication with the authorised device is lost. The third transmission rate may be higher than the second transmission rate. The third transmission rate may, for example, comprise transmitting the polling signal once every 250 milliseconds (corresponding to a transmission rate of 240 signals per minute).

Determining the location of the authorised device may comprise receiving a response signal from the authorised device and processing the response signal to determine a location of the authorised device. The processing of the response signal may comprise triangulating the response signal.

The one or more controller may be configured to actuate the handle deployment mechanism when the reference velocity is determined to be less than a second velocity threshold. The second velocity threshold may be less than the first velocity threshold. The second velocity threshold may be zero. However, the second velocity threshold is preferably greater than zero.

The one or more controller may be suitable for controlling a plurality of handle deployment mechanisms. The one or more controller may be configured to compare the determined location of the authorised device to a plurality of the target zones, each target zone being associated with a respective one of the plurality of handle deployment mechanisms. The handle deployment mechanisms may each be associated with a respective aperture closure member.

The one or more controller may be configured to identify which one of the plurality of target zones the authorised device is located within. The first actuation signal may be output to the handle deployment mechanism associated with the identified target zone.

The one or more controller may identify one or more device which are disposed inside the vehicle, for example inside a cabin of the vehicle. The one or more controller may differentiate between a device(s) inside the vehicle or a device(s) outside the vehicle. The one or more controller may be configured not to deploy a handle(s) in dependence on identification of a device inside the vehicle. The one or more controller may be configured to instruct the one or more device disposed inside the vehicle not to respond to polling signals. This approach may reduce power consumption.

The or each target zone may be disposed outside the vehicle. The or each target zone may be displaced from the associated aperture closure member in a direction of travel of the vehicle. Alternatively, the or each target zone may extend from the associated aperture closure member in a direction of travel of the vehicle. This may facilitate actuation of the handle deployment mechanism as the vehicle approaches the authorised device. Alternatively, or in addition, one or more of the location, extent and direction of the target zone may be modified in dependence on a steering angle of the vehicle.

The one or more controller may be configured to output an unlock signal to a lock mechanism associated with the aperture closure member. The lock mechanism may unlocked in dependence on a determination that the or each authorised device is located within the target zone or one of the target zones.

The one or more controller may be configured to actuate the handle deployment mechanism to retract the handle in dependence on a determination that the at least one authorised device is located outside the or each target zone.

The one or more controller may be configured to retract the handle upon determining that the at least one authorised device exits the target zone (i.e. moves from an inside of the target zone to an outside of the target zone). The one or more controller may output a second actuation signal to the handle deployment mechanism to retract the handle in dependence on a determination that the at least one authorised device is located outside the or each target zone. The one or more controller may be configured to actuate the handle deployment mechanism to retract the handle in dependence on a determination that the at least one authorised device is located outside the or each target zone for a predetermined time period.

The aperture closure member may be a door for ingress to a cabin of the vehicle. The aperture closure member may be a tailgate for access to a load space of the vehicle.

In a variant, the system may be employed for controlling deployment of a side step on the vehicle. The side step may, for example, comprise a platform which is movable between a retracted position and a deployed position. The one or more controller may be configured automatically to displace the side step to the deployed position in dependence on detection of an authorised device in a target zone. This may be used in conjunction with the deployment of the handle; or instead of deployment of the handle.

The communication with the device disposed external to the vehicle may comprise transmitting a polling signal. The polling signal may be transmitted to initiate communication with the authorised device. The device may transmit a signal in dependence on receipt of the polling signal. The one or more controller may be configured to reduce a transmission rate of the polling signal when a vehicle reference velocity increases above a first velocity threshold. The one or more controller may be configured to increase the transmission rate of the polling signal in dependence on detection of a decrease in the vehicle reference velocity below a second velocity threshold.

According to an aspect of the present invention there is provided a system for controlling communication with a device disposed external to the vehicle; the system comprising:
a transceiver for communicating with a device, the communication with the device comprising transmitting a polling signal; and
a control unit comprising one or more controller configured to:
   reduce a transmission rate of the polling signal when a vehicle reference velocity increases above a first velocity threshold;
   increase the transmission rate of the polling signal in dependence on detection of a decrease in the vehicle reference velocity below a second velocity threshold.

At least in certain embodiments, increasing the transmission rate of the polling signal may facilitate identification of the device (or devices).

The transmission rate of the polling signal may be increased to detect an authorised device disposed external to the vehicle.

This may facilitate detection of one or more authorised device.

The controller may be used to provide passive entry into the vehicle, for example to unlock a door lock. Alternatively, or in addition, the controller may be incorporated into the passenger pickup function described herein. For example, the The increased transmission rate may, for example, be applicable when operating in a search mode, as described herein.

The transmission rate of the polling signal may be reduced at least substantially to zero (0) when the vehicle reference velocity increases above the first velocity threshold. Thus, the transmission of the polling signal may be inhibited.

According to a further aspect of the present invention there is provided a vehicle comprising a system as described herein.

According to a further aspect of the present invention there is provided a method of controlling at least one handle deployment mechanism associated with an aperture closure member of a vehicle; the method comprising:
identify an authorised device disposed;
determine a location of the authorised device relative to the vehicle;
compare the determined location of the at least one authorised device to one or more target zone; and
actuate the handle deployment mechanism for deploying a handle in dependence on a determination that the authorised device is located within the target zone or one of the target zones.

The identification of the authorised device may comprise determining that a vehicle reference velocity has decreased to less than a first velocity threshold. In dependence on the determination, the method may comprise initiating generation of the polling signal or increasing a transmission rate of the polling signal.

Determining the location of the authorised device may comprise triangulating the position of the authorised device in dependence on the transmission and/or receipt of one or more wireless signals.

The method may comprise actuating the handle deployment mechanism when the reference velocity decreases to less than a second velocity threshold, the second velocity threshold being less than the first velocity threshold.

The method may comprise comparing the determined location of the authorised device to a plurality of the target zones, each target zone being associated with a respective one of the plurality of handle deployment mechanisms.

The method may comprise identifying which one of the plurality of target zones the authorised device is located within; and operating the handle deployment mechanism associated with the identified target zone.

The method may comprise actuating the handle deployment mechanism to retract the handle in dependence on a determination that the at least one authorised device is located outside the or each target zone.

According to a further aspect of the present invention there is provided a non-transitory computer-readable medium having a set of instructions stored therein which, when executed, cause a processor to perform the method described herein.

Any control unit or controller described herein may suitably comprise a computational device having one or more electronic processors. The system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller or control unit, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. The control unit or controller may be implemented in software run on one or more processors. One or more other control unit or controller may be implemented in software run on one or more processors, optionally the same one or more processors as the first controller. Other suitable arrangements may also be used.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the present invention will now be described, by way of example only, with reference to the accompanying figures, in which:

FIG. 1 shows a schematic representation of a vehicle comprising a system for controlling deployment of one or more vehicle systems;

FIG. 2 shows a schematic representation of a deployment mechanism for deploying a handle in the vehicle shown in FIG. 1;

FIG. 3 shows a schematic representation of the controller in the system shown in FIG. 1;

FIG. 4 shows a schematic representation of the target zones defined in relation to the vehicle; and

FIG. 5 shows a block diagram representing operation of a system in accordance with an embodiment of the present invention.

### DETAILED DESCRIPTION

A system 1 for controlling deployment of systems in a vehicle 3 in accordance with an embodiment of the present invention will now be described with reference to the accompanying figures. During a passenger pickup, the vehicle 3 comes to a halt to enable the passenger to enter the vehicle 3. The system 1 is configured to control deployment of one or more handles on the vehicle 3 to facilitate the passenger pickup.

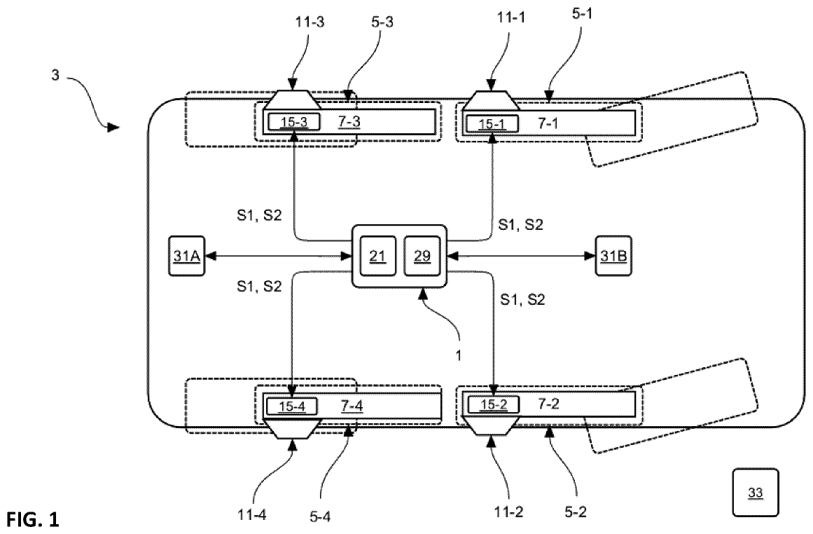

As shown in FIG. 1, the vehicle 3 comprises a plurality of apertures 5-n for ingress into and egress from the vehicle 3. A closure member 7-n is associated with each of the apertures 5-n. The apertures 5-n in the present embodiment are in the form of door openings; and the closure members 7-n are in the form of doors. The vehicle 3 which has a front left first door 7-1, a front right second door 7-2, a rear left third door 7-3 and a rear right fourth door 7-4.

As shown in FIG. 1, a latch mechanism 9-n is associated with each of the closure members 7-n. The latch mechanism 9-n is operable to secure respective closure members 7-n. Each latch mechanism 9-n may, for example, comprise a latch member (not shown) for releasably engaging a door latch pin (not shown). Each latch mechanism 9-n can be controlled remotely, for example to provide a central locking function. Other types of latch mechanism 9-n are also contemplated. The vehicle 3 comprises a plurality of handles 11-n disposed externally of the vehicle 3 and operable to actuate the latch mechanisms 9-n.

The handles 11-n are each associated with a respective one of the latch mechanisms 9-n. The handles 11-n are manually operated in a conventional manner to release the associated latch mechanism 9-n, thereby enabling opening of the closure member 7-n. The handles 11-n may, for example, undergo a pivoting motion to actuate the latch mechanism 9-n. In the present embodiment, the handles 11-n on the vehicle 3 have like configurations. For the sake of brevity, a first handle 11-1 associated with a first closure member 7-1 will now be described. It will be understood that the other handles 11-n have substantially the same configuration.

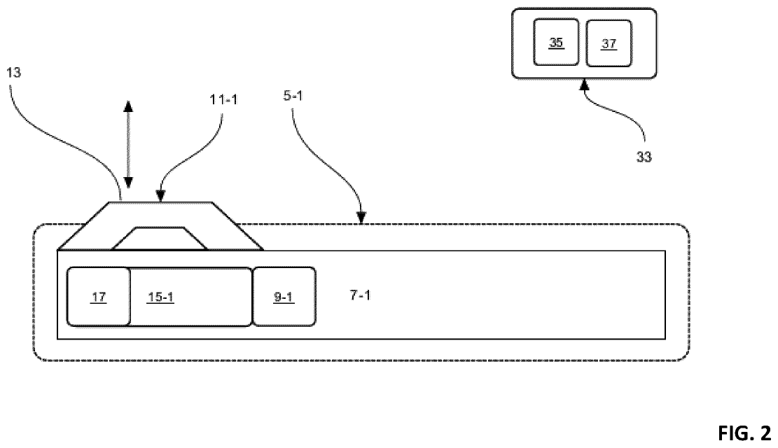

As shown in FIG. 2, the first handle 11-1 is movably mounted in the first closure member 7-1. The first handle 11-1 is movable between a retracted position and a deployed position. The first handle 11-1 is disposed at least substantially within an interior of the first closure member 7-1 in the retracted position; and is disposed outside of the first closure member 7-1 in the deployed position. When disposed in the retracted position, the first handle 11-1 cannot be operated due to the limited access available. When disposed in the deployed position, the first handle 11-1 can be operated in a conventional manner to actuate the latch mechanism 9-n. It will be understood that the first handle 11-1 is disposed in the retracted position to improve aerodynamic efficiency. For example, the first handle 11-1 may be retracted to the retracted position when a vehicle reference velocity VREF of the vehicle 3 increases above a predetermined first velocity threshold TH1. The first handle 11-1 is displaced to the deployed position to enable operation of the handle 11-1. The first handle 11-1 has an outer surface 13. When retracted, the outer surface 13 forms a continuation of the external profile of the first closure member 7-1. When extended, the outer surface 13 of the first handle 9-1 is offset outwardly from the external profile of the first closure member 7-1.

A lock mechanism (not shown) may be provided selectively to lock the latch mechanisms 9-n to inhibit opening of the associated closure members 7-n. Alternatively, or in addition, each handle 11-n may be selectively coupled to the associated latch mechanism 9-n. The latch mechanism 9-n may be disconnected from the handle 11-n to prevent operation of the latch mechanism 9-n when the handle 11-n is operated, thereby locking the closure member 7-n. The latch mechanism 9-n may be connected to the handle 11-n to enable operation of the latch mechanism 9-n when the handle 11-n is operated, thereby unlocking the door. A releasable coupling mechanism, for example comprising an electromagnet or an electromechanical coupler, may be provided for selectively connecting and disconnecting the handle 11-n.

The first handle 11-1 is mounted on a handle deployment mechanism 15-1. The handle deployment mechanism 15-1 is operable selectively to displace the first handle 11-1 between the retracted position and the deployed position. The handle deployment mechanism 15-1 comprises an actuator 17 and a frame 19 for carrying the first handle 11-1. The handle deployment mechanism 15-1 is disposed in an interior of the first closure member 7-n. The actuator 17 actuates the frame 19 so as to displace the first handle 11-1 between the retracted position and the deployed position. The actuator 17 comprises an electromechanical actuator, such as a solenoid. The actuator 17 in the present embodiment is a two-way actuator enabling controlled retraction and deployment of the first handle 11-1. In a variant, the actuator 17 could be a one-way actuator which operates in conjunction with a biasing member controllably to retract and extend the first handle 11-1.

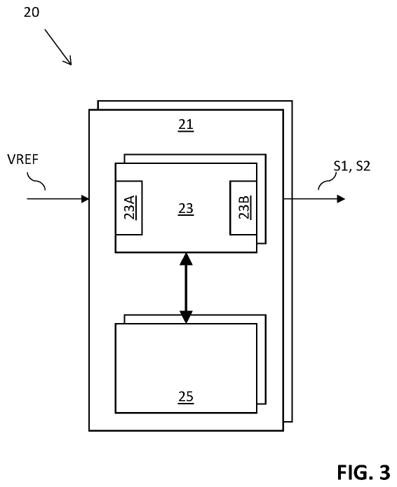

As shown in FIG. 3, the system 1 comprises a control unit 20 having a controller 21 for controlling operation of the actuator 17 selectively to deploy and retract the first handle 11-1. The controller 21 comprises at least one electronic processor 23 and a system memory 25. A set of computational instructions is stored on the system memory 25. When executed the instructions cause the at least one electronic processor 23 to perform the method(s) described herein. The at least one electronic processor 23 has an electrical input 23A for receiving a reference velocity signal VREF; and at least one electrical output 23B for outputting one or more control signal Sn. The at least one electronic processor 23 is configured to generate at least one actuation signal to control operation of the actuator 17. The at least one electronic processor 23 is configured to generate a first deployment signal S1 to cause the actuator 17 to displace the first handle 11-1 from the retracted position to the deployed position, thereby deploying the first handle 11-1. The at least one electronic processor 23 is configured to generate a second retraction signal S2 to cause the actuator 17 to displace the first handle 11-1 from the deployed position to the retracted position, thereby retracting the first handle 11-1. The at least one electronic processor 23 is configured to control operation of the actuator 17 in dependence on a geospatial location of a device 33 associated with the vehicle 3. The device 33 is a portable device suitable for carrying the person of a user, for example in a hand or pocket of the user. The device 33 may be disposed external to the vehicle 3. As described herein, the at least one electronic processor 23 is configured to actuate the handle deployment mechanism 15-1 to deploy the first handle 11-1 in dependence on a determination that the device 33 is located within a target zone Z1 (or one of a plurality of target zones Zn) defined in relation to the vehicle 3. The or each target zone Zn may be defined externally of the vehicle 5.

The system 1 comprises a vehicle transceiver 29 for transmitting and receiving a wireless (RF) signal. The vehicle transceiver 29 in the present embodiment is an ultra-wideband transceiver. In a variant, the vehicle transceiver 29 may be Low Frequency (LF) transceiver or an Ultra High Frequency (UHF) transceiver. The vehicle transceiver 29 is configured to communicate with the device 33. The vehicle transceiver 29 is connected to at least one antenna 30 for transmitting and receiving a wireless (RF) signal. In the illustrated arrangement, the vehicle transceiver 29 is connected to first and second antennas 31A, 31B disposed on the vehicle 3. The first and second antennas 31A, 31B are spaced apart from each other on the vehicle 3. In certain embodiments, the vehicle transceiver 29 may comprise a low energy system suitable for local (short-range) communications, for example to a establish a wireless personal area network. The low energy system may be configured to make an initial connection with the device 33. A suitable low energy system is Bluetooth® Low Energy. The vehicle transceiver 29 may be a dedicated device for communicating with the or each device 33. Alternatively, the vehicle transceiver 29 may perform other functions, such as determining with which satellite (SAT) to communicate.

The device 33 comprises a device controller 35 and a device transceiver 37 for transmitting and receiving a wireless (RF) signal. The device transceiver 37 in the present embodiment is an ultra-wideband transceiver for communicating with the vehicle transceiver 29 disposed on the vehicle 3. The device controller 35 comprises a processor (not shown) and a memory system (not shown). In the present embodiment, the device 33 functions as an electronic key for controlling locking and/or unlocking of the closure members 7-n. The device 33 is authorised at least insofar as there is a pre-existing association with the vehicle 3 (or a pre-established digital connection with the vehicle 3). For example, the device 33 may be electronically paired with the vehicle 3. An authentication process may be performed to authorise the device 33, for example comprising sharing unique identification codes (numerical or alphanumeric) between the device 33 and the vehicle 3. The device 33 in the present embodiment is a dedicated electronic key, for example in the form of a key fob. In a variant, the device 33 may be a general-purpose computational device, such as a cellular telephone. The cellular telephone may function as an electronic key, for example by confirming user identify. The device 33 may be configured to execute a software application for communicating with the vehicle 3, for example to identify the device 33 and to establish communication with the controller 21.

An electronic “handshake” function is performed to establish communication between the vehicle 3 and the device 33. The controller 21 generates a polling signal which is transmitted wirelessly by the vehicle transceiver 29 to the device 33. The polling signal is received by the device 33 via the device transceiver 37. In response to the polling signal, the device 33 transmits an identification signal to the vehicle transceiver 29. The identification signal comprises a unique identification code for identifying the device 33. The controller 21 receives the identification signal and processes the unique identification code. The controller 21 compares the received unique identification code to a set of stored identification codes to determine if the device 33 is classified as an authorised device. Each identification code stored in the set may provide a unique identification of the device 33 already associated with the vehicle 3. If the unique identification code is not present in the stored set, no further communication is performed between the controller 21 and the device 33. If the unique identification code is present in the stored set, the controller 21 classifies the device 33 as an authorised device 33. The controller 21 may attempt to authorise the device 33 by way of a challenge response or similar. The controller 21 communicates with the authorised device 33 to determine a geospatial location of the authorised device 33 relative to the vehicle 3. The time-of-flight for transmission of signals between the vehicle transceiver 29 and the device transceiver 37 enables determination of a distance (range) to the device 3. Alternatively, or addition, a signal strength of the signals transmitted by the vehicle transceiver 29 and the device transceiver 37 may be used to determine of a distance (range) to the device 3. By comparing the time-of-flight for signals transmitted by and/or received by the first and second antennas 31A, 31B, trilateration (true-range multilateration) can be used to determine a relative location of the device 3. The determination of the range and/or the heading of the authorised device 33 may be determined by the controller 21 and/or the device controller 35. Other techniques may be used to determine the geospatial location of the authorised device 33. For example, the geospatial location of the authorised device 33 may be determined by communicating with a satellite positioning system. The authorised device 33 may transmit geospatial location data to the controller 21. The relative location of the authorised device 33 and the vehicle 3 may then be determined.

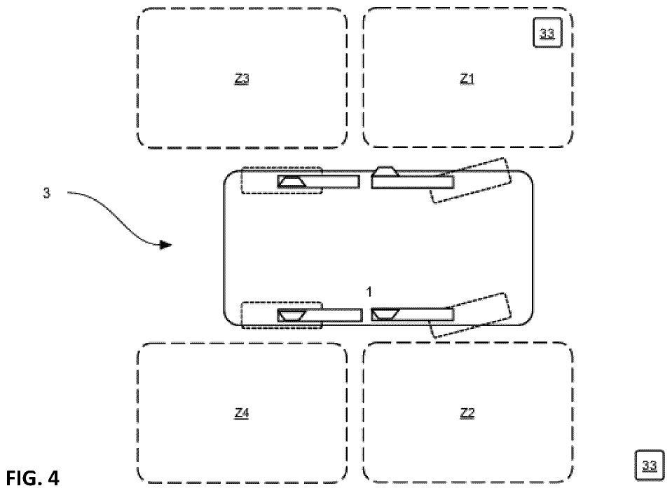

As shown in FIG. 4, a plurality of the targetzones Zn are defined in relation to the vehicle 3. Each targetzone Zn is associated with a respective one of the closure members 7-n. A first target zone Z1 is associated with the first closure member 7-1; a second target zone Z2 is associated with the second closure member 7-2; a third target zone Z3 is associated with the third closure member 7-3; and a fourth target zone Z4 is associated with the fourth closure member 7-4. Each target zone Zn may have a fixed profile. Alternatively, each target zone Zn may have a profile which may be modified dynamically, for example in dependence on one or more operating parameters of the vehicle 3 (such as the vehicle reference velocity VREF and/or a steering angle). The profiles of the target zones Zn may be stored in the memory device and accessed by the at least one electronic processor 23. In the scenario illustrated in FIG. 4, the first handle 11-1 associated with the first closure member 7-1 is in a deployed position (as an authorised device 33 is present in the first zone Z1); and the second, third and fourth handles 11-2, 11-3, 11-4 are in their retracted positions (as no authorised devices 33 are detected in the respective second, third and fourth zones Z2, Z3, Z4).

The handles 11-n are typically retracted when the vehicle reference velocity VREF increases above the first threshold value TH1, for example as the vehicle velocity increases after the driver enters the vehicle. The handles 11-n may remain in their retracted state until the vehicle 3 is brought to a stop, potentially also requiring a user input or action such as detecting opening of a driver door. This functionality may be undesirable during a passenger pickup when the vehicle 3 is slowed momentarily to collect a passenger. In prior art systems the handles 11-n may remain in their retracted position pending a user input or action. This may delay opening of the closure member 7-n. The system 1 described herein is operative automatically to control operation of the handle deployment mechanisms 15-n.

The system 1 is operable to identify one or more indicator of a passenger pickup. As described herein, the indicator(s) may comprise or consist of: (a) one or more vehicle operating parameter, such as vehicle velocity, vehicle braking, vehicle steering angle; and/or (b) external factors, such as the presence and/or the location of an authorised device. The one or more vehicle operating parameter may comprise or consist of the vehicle velocity, for example identifying vehicle deceleration resulting in the reference vehicle velocity VREF decreasing below a predefined second velocity threshold TH2. Other vehicle operating parameters may include a steering angle of the vehicle 3, for example to identify a steering angle indicative of the vehicle 3 pulling over to a side of the road or highway; and/or a demand for vehicle braking greater than a predefined braking threshold.

The system 1 is configured to detect the presence of a candidate passenger indirectly by identifying an authorised device 33 having a pre-existing association with the vehicle 3.

In the present embodiment, the vehicle reference velocity VREF is used as an entry condition for initiating a search to identify the presence of one or more authorised device 33. In particular, the controller 21 initiates the search when the reference vehicle velocity VREF decreases below a second velocity threshold TH2. The second velocity threshold TH2 may, for example, be set at 3 kph, 5 kph, 10 kph or 20 kph. The search comprises transmitting a polling signal to establish communication with any local devices 33. The transmission rate (or polling rate) with which the polling signal is transmitted may change when the search is initiated. For example, the polling signal may be transmitted at a first transmission rate under normal operating conditions; and at a second transmission rate under search conditions. The second transmission rate is higher than the first transmission rate. The first transmission rate may be zero or may be greater than zero.

The transmission range of the vehicle transceiver 29 limits the extent of the search. Any devices 33 which receive the polling signal respond by transmitting an authentication signal. The authentication signal may, for example, comprise a unique identification code, thereby enabling identification of the device 33. The controller 21 processes the identification code to determine if the device 33 is an authorised device. An authorised device 33 may, for example, be one which has previously been paired with the vehicle 3 or having a pre-existing association with the vehicle 3. If the device 33 is not authorised, the controller 21 does not take any further action in respect of that device.

The controller 21 determines the presence of an authorised device 33 as indicating a candidate individual for a passenger pickup. In the present embodiment, the controller 21 also identifies the position of the authorised device 33 in relation to the vehicle 3. The controller 21 identifies when the authorised device 33 enters one of the predefined target zones Zn. If the location of the authorised device 33 is coincident with one of the predefined target zones, the controller 21 determines that the vehicle 3 is performing a passenger pickup. The controller 21 is then operative to deploy one or more of the handles 11-n automatically to facilitate opening of the associated closure member 7-n. The system 1 in the present embodiment identifies one or more of the handles 11-n to be opened in dependence on the location of the or each authorised device 33 in relation to the vehicle 1. The target zones are each associated with one of the handles 11-n. The controller 21 is configured to deploy the handle 11-n associated with the target zone in which the authorised device 33 is located. The at least one electronic processor 23 generates the first deployment signal S1 to cause the actuator 17 to displace the handle 11-n from the retracted position to the deployed position, thereby deploying the handle 11-n. The first deployment signal S1 may be generated while the vehicle 3 is still moving, thereby at least initiating the deployment of the handle 11-n before the vehicle 3 comes to a stop. If the controller 21 determines that the authorised device 33 is no longer located inside the target zone, the second retraction signal S2 may be generated to retract the handle 11-n. If the door is not opened in a predetermined time period, the second retraction signal S2 may be generated to retract the handle 11-n. Identification of an increase in the speed of the vehicle (VREF) may be used to trigger generation of the second retraction signal S2 to retract the handle 11-n.

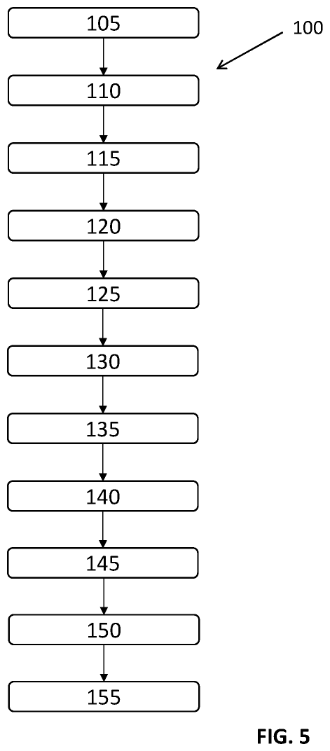

The operation of the system 1 will now be described with reference to a first block diagram 100 shown in FIG. 5. The system 1 is activated (BLOCK 105), for example when a driver enters the vehicle 3. The vehicle reference velocity VREF increases above a first threshold TH1 and a first retraction signal S1 is output to retract each handle 11-n (BLOCK 110). The system determines that the vehicle reference velocity VREF has decreased below a second threshold TH2 (BLOCK 115). A rate of polling for devices 33 is increased (or initiated) to identify any devices 33 within a predetermined range to the vehicle 3 (BLOCK 120). The or each device 33 is interrogated to determine if they are an authorised device 33 or are otherwise associated with the vehicle 3 (BLOCK 125). The location of the or each authorised device 33 is determined (BLOCK 130). The system 1 identifies if the or each authorised device 33 is located in one of the target zones (BLOCK 135). A deployment signal S1 is generated to deploy the handle 11-n associated with the target zone in which the authorised device 33 is detected (BLOCK 140). Optionally, the opening of the closure member 7-n is detected and/or the ingress of the passenger is detected (BLOCK 145). The first retraction signal S1 is output to retract the handle 11-n (BLOCK 150). The system 1 continues to operate until the vehicle 3 is deactivated (BLOCK 155).

It will be appreciated that various modifications may be made to the embodiment(s) described herein without departing from the scope of the appended claims.

The one or more controller may identify one or more device 33 inside the vehicle 3, for example inside a cabin of the vehicle 3. Any such device 33 may be an authorised device, for example associated with a driver of the vehicle 3. The at least one processor may be configured not to deploy a handle(s) 11-n in dependence on identification of an authorised device inside the vehicle 3. Furthermore, the controller 21 may instruct the one or more authorised device 33 disposed inside the vehicle 3 not to respond to polling signals.

The system 1 could be configured to activate a vehicle light, such as a side light or a puddle light (disposed in a wing mirror of the vehicle 3), in dependence on the determination that an authorised device 33 is located within the target zone or one of the target zones.

The system 1 could be configured to unlock a door locking mechanism in dependence on the determination that an authorised device 33 is located within the target zone or one of the target zones.

The system 1 has been described herein with particular reference to the deployment of the handle(s) 11-n. Alternatively, or in addition, the system 1 may be employed for controlling deployment of a side step on the vehicle. The side step may, for example, be provided to facilitate entry into the vehicle 3. The system 1 can be configured to deploy the side step as the vehicle 3 approaches to perform a passenger pickup.

As outlined above, trilateration may be used to determine a location of the device 33. A comparison of the determined locations may be used to determine a heading (direction of travel) of the device 33. The determined heading of the device 33 may be used to control actuation of the handle deployment mechanism. This may be used in conjunction with or instead of comparing the location of the or each authorised device to one or more target zone. The determined heading of the device may be used to provide additional information in relation to the device 33, for example to determine if the device 33 is getting closer to the vehicle 5 (approaching) or further away from the vehicle 5 (departing).

The system 1 may store historical data about the movement of the device 33 relative to the vehicle 5. For example, the system 1 may store an approach direction (vector) of the device 33 in dependence on one or more historical use cases. The historical data may, for example, indicate a preference or bias to a user approaching from a first side of the vehicle 5 as opposed to a second side. The handle deployment mechanism may be actuated in dependence on the historic data. The historic data may be associated with a particular device 33, thereby providing an indication of likely behaviour of the user having that device 33.

1-15. (canceled)

16. A system for controlling at least one handle deployment mechanism associated with an aperture closure member of a vehicle; the system comprising:
a transceiver for communicating with at least one device; and
a control unit comprising one or more controller configured to:
identify one of the at least one device which is an authorized device;
determine a location of the or each authorized device in relation to the vehicle;
compare the determined location of the or each authorized device to one or more target zone; and
actuate the handle deployment mechanism for deployment of a handle in dependence on a determination that the or each authorized device is located within the target zone or one of the target zones.

17. A system as claimed in claim 16, wherein the one or more controller collectively comprise:
at least one electronic processor having an electrical input for receiving a reference velocity signal indicating a reference velocity of the vehicle; and
at least one memory device electrically coupled to the at least one electronic processor and having instructions stored therein,
and wherein the at least one electronic processor is configured to access the at least one memory device and execute the instructions therein so as to determine the location of the at least one authorized device.

18. A system as claimed in claim 17, wherein the at least one electronic processor has at least one output for outputting a first actuation signal to actuate the handle deployment mechanism.

19. A system as claimed in claim 16, wherein identification of the authorized device comprises generating a polling signal to initiate communication with one or more device; wherein the generation of the polling signal is initiated or a transmission rate of the polling signal is increased in dependence on a determination that a vehicle reference velocity has decreased to less than a first velocity threshold.

20. A system as claimed in claim 16, wherein determining the location of the authorized device comprises receiving a response signal from the authorized device and processing the response signal to determine a location of the authorized device.

21. A system as claimed in claim 16, wherein the one or more controller is configured to actuate the handle deployment mechanism when the reference velocity is determined to be less than a second velocity threshold, the second velocity threshold being less than the first velocity threshold.

22. A system as claimed in claim 16, wherein the one or more controller is suitable for controlling a plurality of handle deployment mechanisms; the one or more controller being configured to compare the determined location of the authorized device to a plurality of the target zones, each target zone being associated with a respective one of the plurality of handle deployment mechanisms.

23. A system as claimed in claim 22 wherein the one or more controller is configured to identify which one of the plurality of target zones the authorized device is located within; and outputting the first actuation signal to the handle deployment mechanism associated with the identified target zone.

24. A system as claimed in claim 16, wherein the or each target zone is displaced from the associated aperture closure member in a direction of travel of the vehicle; or extends from the associated aperture closure member in a direction of travel of the vehicle.

25. A system as claimed in claim 16, wherein the one or more controller is configured to actuate the handle deployment mechanism to retract the handle in dependence on a determination that the at least one authorized device is located outside the or each target zone.

26. A system as claimed in claim 25, wherein the one or more controller is configured to actuate the handle deployment mechanism to retract the handle in dependence on a determination that the at least one authorized device is located outside the or each target zone for a predetermined time period.

27. A system as claimed in claim 16, wherein the aperture closure member is a door for ingress to a cabin of the vehicle.

28. A system as claimed in claim 16, wherein the aperture closure member is a tailgate for access to a load space of the vehicle.

29. A vehicle comprising a system as claimed in claim 16.

30. A method of controlling at least one handle deployment mechanism associated with an aperture closure member of a vehicle; the method comprising:
identify an authorized device;
determine a location of the authorized device relative to the vehicle;
compare the determined location of the at least one authorized device to one or more target zone; and
actuate the handle deployment mechanism for deploying a handle in dependence on a determination that the authorized device is located within the target zone or one of the target zones.

31. A method as claimed in claim 30, wherein identification of the authorized device comprises determining that a vehicle reference velocity has decreased to less than a first velocity threshold and, in dependence on the determination, initiating generation of the polling signal or increasing a transmission rate of the polling signal.

32. A method as claimed in claim 30, wherein determining the location of the authorized device comprises triangulating the position of the authorized device in dependence on the transmission and/or receipt of one or more wireless signals.

33. A method as claimed in claim 30 comprising actuating the handle deployment mechanism when the reference velocity decreases to less than a second velocity threshold, the second velocity threshold being less than the first velocity threshold.

34. A method as claimed in claim 30 comprising compare the determined location of the authorized device to a plurality of the target zones, each target zone being associated with a respective one of the plurality of handle deployment mechanisms.

35. A non-transitory computer-readable medium having a set of instructions stored therein which, when executed, cause a processor to perform the method as recited in claim 30.
